(19) United States
(12) Patent Application Publication
(10) Pub. No.: US 2014/0377736 A1
(43) Pub. Date: Dec. 25, 2014

(54) MAGNETIC MAT

(71) Applicant: IFIXIT, Atascadero, CA (US)

(72) Inventors: Eric J. Essen, Arroyo Grande, CA (US); Shirley Yang Song, San Luis Obispo, CA (US)

(21) Appl. No.: 14/309,842

(22) Filed: Jun. 19, 2014

Related U.S. Application Data
(60) Provisional application No. 61/838,139, filed on Jun. 21, 2013.

(51) Int. Cl. B43L 1/00

(52) U.S. Cl. CPC B43L 1/008
USPC 434/408

(57) ABSTRACT

A magnetic writable/erasable mat is comprised of at least one magnetically active layer and a writable/erasable surface. The magnetic mat may also include a writable/erasable layer, a backing layer, and an opaque layer. The magnetic mat may also include pre-printed markings for use in organizing, measuring, or instructional applications. The magnetic mat with the writable/erasable surface provides for magnetically attracted items to be secured on the mat while additionally providing for writable annotation or other organizational markings.

This application claims the benefit of U.S. Provisional Application No. 61/838,139, filed Jun. 21, 2013, which is incorporated in its entirety herein by reference.

### BACKGROUND OF THE INVENTION

1. Field of the Invention

The present invention relates generally to writable/erasable surfaces, and more specifically to magnetic writable/erasable surfaces.

2. Discussion of the Related Art

Display boards such as writable/erasable boards (commonly called “white boards” or “dry erase” boards) are commonly used for the presentation of graphics and written material. The display boards may also incorporate a ferrous material, so that the surface is capable of receiving magnets. Alternately, the display board may include an actively magnetic material. Such display boards are commonly mounted on a vertical surface or displayed at a substantially vertical orientation.

Writable/erasable display boards typically include a surface coating configured to receive dry-erase marker writing and later remove the dry-erase markings. The surface coating may be any coating that allows for the dry-erase marker writing and erasing, for example glass, melamine, porcelain, vinyl chloride, or acrylic.

Magnetic trays are also known in the art for organizing and storing magnetically attracted items.

### SUMMARY OF THE INVENTION

Several embodiments of the invention advantageously address the needs above as well as other needs by providing a magnetic mat.

In one embodiment, the invention can be characterized as a mat comprising a writable/erasable surface configured to accept applied markings which can be erased, the outer writable/erasable surface further including at least on pre-printed marking, and a magnetically active layer.

In another embodiment, the invention can be characterized as a mat comprising a first writable/erasable surface configured to accept applied markings which can be erased, a second writable/erasable surface opposite to the first writable/erasable surface, wherein the second writable/erasable surface includes pre-printed markings, and a magnetically active layer.

In a further embodiment, the invention may be characterized as a mat, comprising: a first clear writable/erasable layer, a first opaque layer coupled to the bottom of the clear layer, a first magnetically active layer coupled to the bottom of the opaque layer; a second magnetically active layer coupled to the bottom of the first magnetically active layer, a second opaque layer coupled to the bottom of the second magnetically active layer, and a second clear writable/erasable layer coupled to the bottom of the second opaque layer.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a perspective view of a magnetic mat in accordance with one embodiment of the invention.

FIG. 2 is a perspective view of a magnetic mat in accordance with another embodiment of the invention.

FIG. 3 is a perspective view of a magnetic mat in accordance with yet another embodiment of the invention.

FIG. 4 is a perspective view of a magnetic mat in accordance with yet another embodiment of the invention.

FIG. 5 is a perspective view of a magnetic mat in accordance with yet another embodiment of the invention.

FIG. 6 is a perspective view of the magnetic mat in accordance with FIGS. 1-5.

FIG. 7 is a perspective view of a surface opposite to a writable/erasable surface of the magnetic mat in accordance with FIGS. 1-5.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Referring first to FIG. 1, a writable/erasable magnetic mat 100 in one embodiment of the present invention is shown. Shown are a magnetic layer 102 and a writable/erasable surface 104.

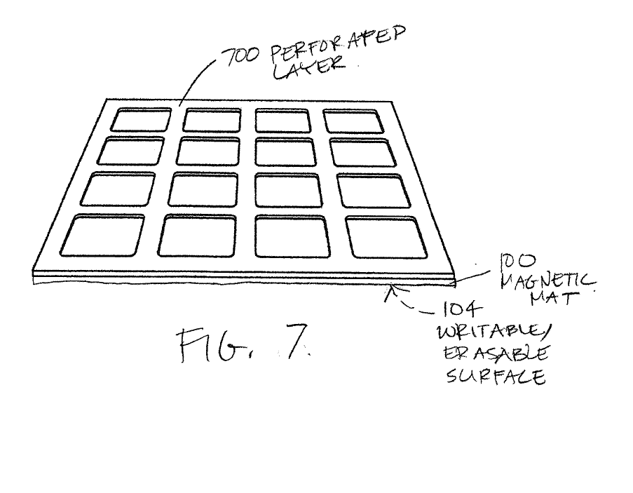

The magnetic mat 100 may be comprised of the single magnetic layer 102 of non-porous magnetically active material, for example a polymer or ceramic-based material including ferrous material. In some embodiments, the magnetically active magnetic layer 102 exhibits magnetism in the range of 1×10⁻⁶ Tesla to 1.25 Tesla. The magnetic layer 102 includes at least one writable/erasable surface 104 suitable for receiving at least one erasable marking 600 from a marker 604 (as shown below in FIG. 6) and also allowing for the markings 600 to be fully erased from the writable/erasable surface 104. In some embodiments, the marker 604 may be a dry erase marker. In other embodiments, the marker may be chalk, pencil, felt-tipped marker or any other writing instrument suitable for erasable writing on the writable/erasable surface.

In one embodiment, the writable/erasable surface 104 of the magnetic layer 102 may be polished to configure the writable/erasable surface 104 to receive/erase the marking 600.

The magnetic mat 100 as shown in FIG. 1 may be configured in a square shape, as shown in FIG. 1, or other shapes, for example, but not limited to, a rectangle, circle or oval. The magnetic mat 100 may be made in various sizes. In one embodiment the magnetic mat 100 is about one centimeter square, which would allow it to be mountable on wearable objects. In larger embodiments multiple larger magnetic mats 100 could be wall-mounted to cover an entire vertical surface (for example, a wall) or other large surface (for example, a table).

The single layer magnetic mat 100 does not require any additional manufacturing to attach it to another layer. The flexibility of the magnetic mat 100 as shown in FIG. 1 may be varied by varying the thickness of the magnetic mat 100, as well as the flexibility being determined by the stiffness of the material and the shape selected. In one embodiment, the magnetic mat 100 is configured to bend at least 90 degrees along a length of the magnetic mat 100, for example to allow the magnetic mat 100 to be mounted on a corner. In another embodiment, the magnetic mat 100 is configured to bend less than one degree along the length of the magnetic mat 100, for example when the magnetic mat 100 is used as a stand-alone work surface. In yet another embodiment, the magnetic mat 100 is configured to allow for rolling of the magnetic mat 100 into a tube, for example to aid in storing of the magnetic mat.

While the magnetic mat 100 is shown as a single planar sheet, in some embodiments the magnetic mat 100 may be formed in three-dimensional shapes, for example, cubes, spheres or pyramids, or any other three-dimensional shape. In the three-dimensional configuration, the writable/erasable surface 104 is located on an outside surface of the three-dimensional surface. In some embodiments the writable/erasable surface 104 may cover the entire outside surface, while in other embodiments the writable/erasable surface 104 may be used on a portion of the outside surface.

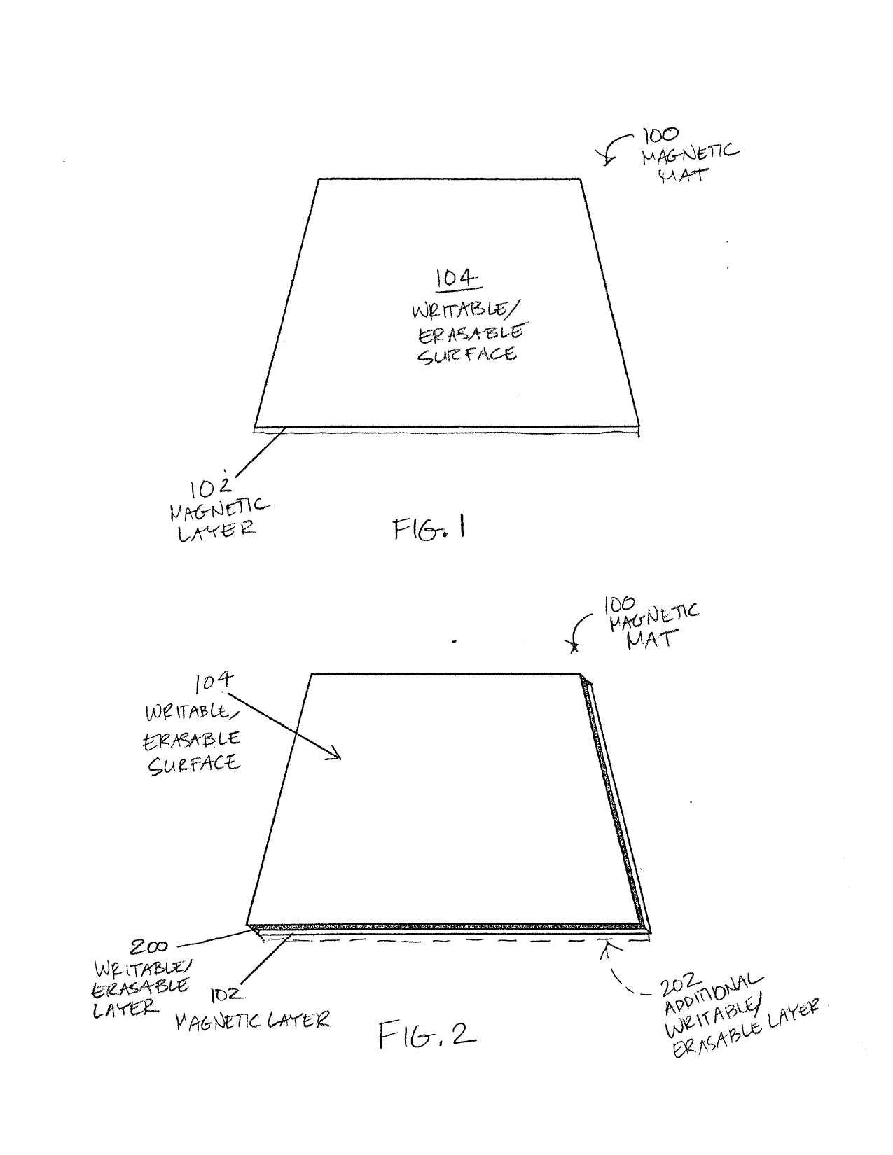

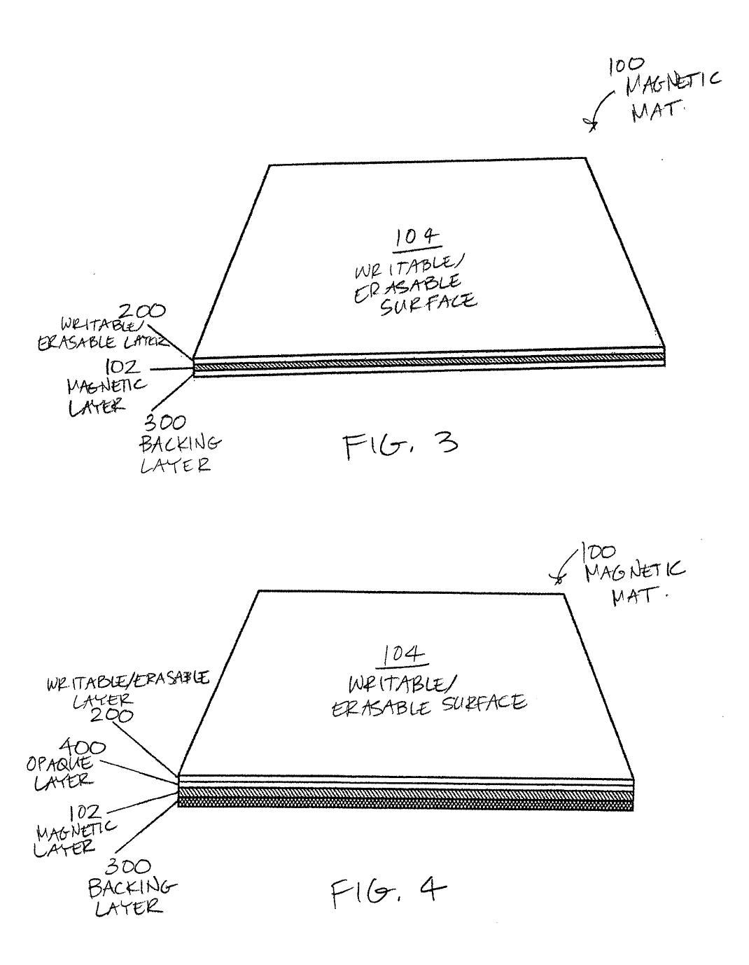

Referring next to FIG. 2, the magnetic mat 100 in another embodiment of the present invention is shown. Shown are the magnetic layer 102, the writable/erasable surface 104, a writable/erasable layer 200, and an optional additional writable/erasable layer 202.

Shown in FIG. 2 is a two-layered embodiment of the magnetic mat 100. The magnetic layer 102 is coupled to the writable/erasable layer 200. The writable/erasable layer 200 includes the outward-facing writable/erasable surface 104.

In some embodiments, the magnetic layer 102 is coupled to the writable/erasable layer 200 using a permanent or nonpermanent adhesive. In another embodiment, the magnetic layer 102 is coupled to the writable/erasable layer 200 by a cold lamination process. In another embodiment, the magnetic layer 102 is coupled to the writable/erasable layer 200 by a heat lamination process wherein the magnetic layer 102 is encased by the writable/erasable layer 200 through the cold lamination process. In yet another embodiment, the writable/erasable layer 200 may be a sprayed-on coating layer. The sprayed-on coating may form the writable/erasable surface 104 upon drying, or may be further polished or cured to form the writable/erasable surface 104. In another embodiment, the magnetic layer 102 may be coupled to the writable/erasable layer 200 using mechanical coupling, for example by lacing the layers together using cord or thread, or by using clips. In yet another embodiment, the writable/erasable layer 200 may comprise a sticker applied to the magnetic layer 102.

The magnetic properties of the magnetically active magnetic layer 102 can derive from any type of permanent or temporary magnet. In some embodiments, the magnetically active magnetic layer 102 exhibits magnetism in the range of 1×10⁻⁶ Tesla to 1.25 Tesla. In one embodiment, a temporary magnet may be formed from a current passing through electromagnetic material. Examples of permanent magnets include, but are not limited to, nickel magnets, cobalt magnets, iron magnets, rare earth magnets, rubber magnets, and ceramic magnets. The magnetism is directed towards the writable/erasable surface 104.

The magnetic layer 102 may comprise non-magnetic materials, for example the magnetic layer 102 may comprise active magnetic elements suspended in a matrix medium such as rubber or ceramic. The magnetic layer 102 may comprise a single magnet or may include multiple magnets, for example, strips of flat magnets. In one embodiment, multiple magnets are arranged in a grid pattern, enabling a “snap-to-grid” placement of objects on the magnetic mat 100. In other embodiments, magnets are arranged in the magnetic layer 102 to provide alternate snapping configurations, such as snapping to a box pre-printed on the writable/erasable layer 200.

In the embodiments including multiple magnets, the magnets may be arrayed to present only a single pole at a time, or can be arrayed to produce specific magnetic fields, for example, a Halbach Array field or correlated coded poles. In some embodiments, the magnetic field is only directed towards the writable/erasable surface 104. In other embodiments, the magnetic field is directed towards both the writable/erasable surface 104 and a surface opposite to the writable/erasable surface 104.

The magnetic mat 100 may include the additional writable/erasable layer 202 (also including the writable/erasable surface 104) coupled to a surface of the magnetic layer 102 opposite to the writable/erasable layer 200, either formed with the writable/erasable layer as part of the manufacturing process (for example cold lamination) or added separately. The additional writable/erasable layer 202 may be substantially similar to the writable/erasable layer 200 or may be of different composition.

Referring again to FIG. 2, the writable/erasable layer 200 may comprise a clear or opaque material suitable for writing and erasing such as slate, glass, polyvinyl chloride, and polypropylene. The writable/erasable layer 200 may also be applied as a coating layer to the magnetic layer 102, as previously mentioned. Examples of a coating writable/erasable layer 200 may include paint, lamination, or a UV-cured solution.

The stiffness of the magnetic mat 100 may be additionally varied due to the material type and thickness of the writable/erasable layer 200. In one embodiment, the flexible magnetic mat 100 has a total thickness of about 0.01 inches and 0.5 inches. In another embodiment, the stiff magnetic mat 100 has an overall thickness of about 0.1 inches to 72 inches. The material used for the writable/erasable layer 200 also contributes to the flexibility of the magnetic mat 100.

In one embodiment, the magnetic mat 100 may be manufactured by forming a large sheet of magnetically active material (the magnetic layer 102) which is laminated with the writable/erasable layer 200 and optionally cut in to smaller sheets using dies or cutting blades.

In another embodiment, the magnetic mat 100 may be manufactured via an injection molding process to form the writable/erasable layer 200, which is then used as a casing for the magnetic layer 102.

In yet another embodiment, the magnetic mat 100 may be manufactured by immersing the magnetic layer 102 in a liquid medium, which will subsequently harden to form the writable/erasable layer 200.

In yet another embodiment, the magnetic mat 100 may be manufactured through 3D printing of the magnetic layer 102, followed by printing of an adhesive layer on the magnetic layer 102, and then printing of the writable/erasable layer 200 on the adhesive layer.

Referring next to FIG. 3, a three-layer embodiment of the magnetic mat 100 is shown. Shown are the magnetic layer 102, the writable/erasable surface 104, the writable/erasable layer 200 and a backing layer 300.

The three-layer embodiment of the magnetic mat 100 as shown in FIG. 3 includes the magnetic layer 102 coupled to and sandwiched between the writable/erasable layer 200 and the backing layer 300. The writable/erasable layer 200 and the magnetic layer 102 may be as described previously in FIG. 2. The backing layer 300 may comprise wood, foam, metal, rubber, adhesive, or other material suitable for providing required stiffness and/or mounting capabilities. The backing may be coupled to the magnetic layer 102 by the coupling methods previously mentioned in FIG. 2.

The addition of the backing layer 300 provides additional stiffness and mounting capabilities to the magnetic mat 100. For example, the backing layer 300 may comprise the top of a desk or a workbench.

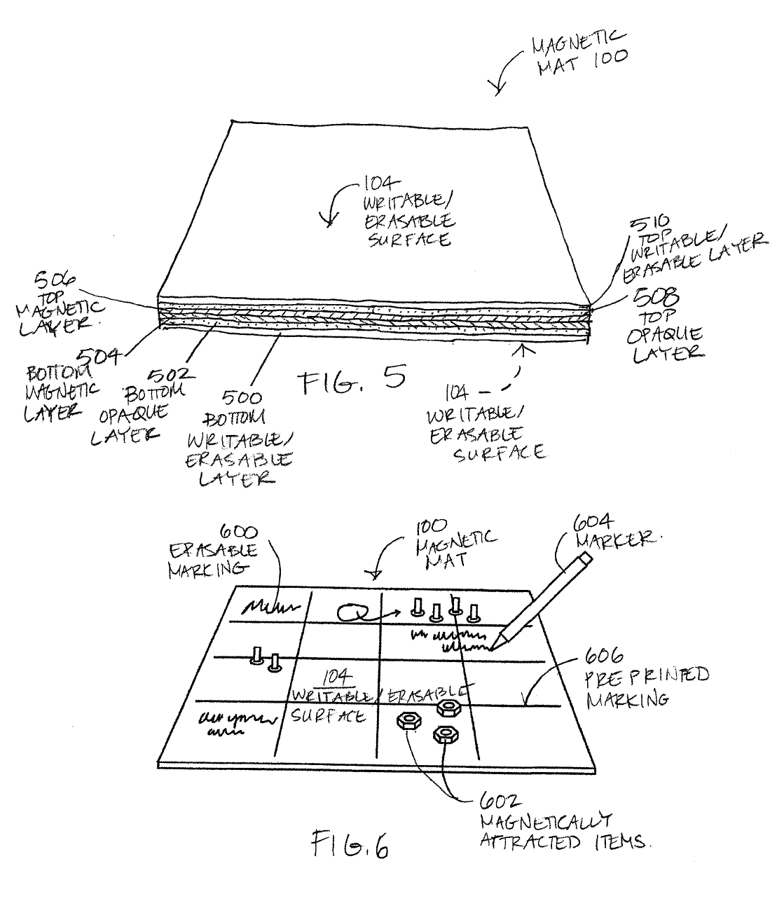

Referring next to FIG. 4, a four-layer embodiment of the magnetic mat 100 is shown. Shown are the magnetic layer 102, the writable/erasable surface 104, the writable/erasable layer 200, the backing layer 300 and an opaque layer 400.

In the embodiment shown in FIG. 4, the magnetic mat 100 includes the bottom backing layer 300. The magnetic layer 102 is coupled to a top surface of the backing layer 300. The opaque layer 400 is coupled to a top surface of the magnetic layer 102. Finally, the writable/erasable layer 200 is coupled to a top surface of the opaque layer 400. The top, outward-facing surface of the writable/erasable layer 200 is the writable/erasable surface 104.

The magnetic layer 102 may be as previously described in FIG. 2, and the backing layer 300 as previously described in FIG. 3. The opaque layer 400 color is configured for contrast between the opaque layer 400 and markings on the writable/erasable surface 104. The opaque layer 400 may comprise vinyl, paper, paint or any other material suitable for opaqueness. The writable/erasable layer 200 in the four-layer embodiment is clear and transparent so as to allow the opaque layer 400 to be visible. The writable/erasable layer 200 may also be non-porous to protect the opaque layer 400. In the four-layer embodiment the writable/erasable layer 200 may comprise polyvinyl chloride, polypropylene, or other material suitable for providing a clear writable/erasable layer 200.

Referring again to FIGS. 2-4, the flexibility of the magnetic mat 100 may be varied by varying the thicknesses and the material types of the magnetic mat layers 100. In one embodiment, the magnetic mat 100 is configured to bend at least 90 degrees along the length of the magnetic mat 100, for example to allow the magnetic mat 100 to be mounted on a corner when the backing layer 300 is an adhesive layer. In another embodiment, the magnetic mat 100 is configured to bend less than one degree along the length of the magnetic mat 100, for example when the magnetic mat 100 is used as a stand-alone work surface (such as having the magnetic mat 100 be used as a tabletop) and the backing layer comprises stainless steel. In yet another embodiment, the magnetic mat 100 is configured to allow for rolling of the magnetic mat 100 into a tube, for example to aid in storing of the magnetic mat. In the tube embodiment, the backing layer 300 may comprise foam.

Referring next to FIG. 5, a six-layer reversible magnetic mat 100 is shown. Shown are the writable/erasable surfaces 104, a bottom writable/erasable layer 500, a bottom opaque layer 502, a bottom magnetic layer 504, a top magnetic layer 506, a top opaque layer 508, and a top writable/erasable layer 510.

The six-layer magnetic mat 100 includes the bottom writable/erasable layer 500 and the bottom opaque layer 502 coupled to a top surface of the bottom writable/erasable layer 500. An outward-facing surface of the bottom writable/erasable layer 500 includes the writable/erasable surface 104.

The bottom magnetic layer 504 is coupled to a top surface of the bottom opaque layer 502, and the top magnetic layer 506 is coupled to a top surface of the bottom magnetic layer 504. The top opaque layer 508 is coupled to a top surface of the top magnetic layer 506, and the top writable/erasable layer 510 is coupled to a top surface of the top opaque layer 508. A top outward-facing surface of the top writable/erasable layer 510 includes the writable/erasable surface 104.

The bottom magnetic layer 504 is actively magnetic towards the bottom writable/erasable layer 500, and the top magnetic layer 506 is actively magnetic towards the top writable/erasable layer 510, i.e. the magnetic directions of the top magnetic layer 506 and the bottom magnetic layer 504 are opposite, allowing magnetically-attracted items to be coupled to both writable/erasable surfaces 104.

The writable/erasable layers 500, 510 and the opaque layers 502, 508 may be as described previously in FIG. 4. The magnetic layers 504, 506 may be as described previously in FIG. 2.

Referring next to FIG. 6, the magnetic mat 100 is shown in one implementation of the invention. Shown are the writable/erasable surface 104, the erasable markings 600, at least one magnetically attracted item 602, the marker 604, and at least one pre-printed marking 606.

As shown in FIG. 6, the magnetic mat 100 may include pre-printed markings 606 applied to the magnetic mat 100 during manufacture of the magnetic mat 100. The pre-printed markings 606 may be permanent or semi-permanent.

In the embodiment shown in FIG. 6, the pre-printed marking 606 comprises a 4×4 grid visible on the writable/erasable surface 104. Other types and configurations of pre-printed markings 606 include, but are not limited to, grids of varying sizes, triangles, check boxes, rulers, squares, pentagons or reference materials. The pre-printed markings 606 may be oriented and/or arranged in any orientation or configuration.

The magnetic layer 102 allows a user to place the magnetically-attracted items 602 on the magnetic mat 100 and have the magnetic mat 100 hold the magnetically-attracted items in place. Examples of magnetically-attracted items 602 can include screws, washers, bolts, metal clips, nails, surgical equipment, metal toy pieces, metal tools, magnetically active components, electronic components, and any other item comprising magnetically-attracted elements. In one embodiment, a color of the writable/erasable surface 104 may contrast color(s) of the magnetically attracted items 602 to allow improved location and identification of the elements 602 when placed on the magnetic mat 100. When the magnetic mat 100 is placed on a substantially horizontal surface, it may be used to store machine parts or assembly parts without having the parts become jumbled if the magnetic mat 100 is jostled or moved. The magnetic mat 100 may also be used for organizational tasks involving magnetically-attracted items 602. The magnetic layer 102 may also be used to secure accessories to the magnetic mat 100, for example a pen holder, a metal tray, or an eraser. The magnetic mat 100 may also be used in a sliding drawer to prevent sliding of magnetically-attracted items 602 when the drawer is opened or closed.

The writable/erasable surface 104 allows for the user to use the marker 604 to add erasable markings 600 to the mat to organize and label the magnetically-attracted items 602 or to records other notes on the magnetic mat 100. The pre-printed markings 606 of the magnetic mat 100 may also be used to illustrate steps, procedures and descriptions, and may further be annotated by the user using the marker 604. The magnetic mat 100 may also include pre-printed markings 606 arranged in any regular or irregular pattern to aid in activities such as taking inventory or assembly. The pre-printed markings may include, but are not limited to, outlines for objects, check boxes, hexagonal patterns, grids, rulers, random lines, and paisley patterns. In some embodiments the pre-printed markings 606 may be correlated to the intended application of the magnetic mat 100. In other embodiments the pre-printed markings 606 may be correlated to an aspect of the magnetic layer 102, for example the pre-printed markings 606 may correspond to a snap-to-grid magnetic feature of the magnetic layer 102.

The magnetic mat 100 may be used in any orientation, and in some embodiments, such as FIG. 5, may be magnetically attractive on both surfaces and/or include a writable/erasable layer 200 on both surfaces.

In some embodiments, at least one layer may also be configured to function as a cutting surface. In one embodiment, the opaque layer 400 may comprise PVC or other soft plastic suitable for cutting upon.

In some embodiments, the surface opposite to the writable/erasable layer 200 includes the pre-printed markings 606, so that the user may secure the magnetically attracted items 602 to the writable/erasable surface 104 and then turn the magnetic mat 100 over to read the pre-printed markings 606 on the opposite surface without dislodging the magnetically attracted items 602.

In another embodiment, the magnetic mat 100 is configured to be wearable by the user, for example coupled to a wristband for wearing by the user, or integrated into a piece of clothing such as an apron.

In an embodiment where the magnetic layer 102 includes the Halbach array field, the properties of the Halbach array field provide for multiple magnetic mats 100 holding magnetically attracted items 602 to be stacked on top of one another without disturbing the locations of the magnetically attracted items 602.

In another embodiment, the magnetic mat may be utilized with a semi-permanent overlay. The semi-permanent overlay may include additional pre-printed markings.

In another embodiment, at least one connector may be coupled to the surface opposite to the writable/erasable surface 104 so that the magnetic mat 100 may be mounted on a separate surface such as a table or wall. The at least one connector may comprise adhesive foam, a magnet, double-stick tape, or other connector suitable for mounting the magnetic mat to the desired surface.

In yet another embodiment, multiple writable/erasable layers 200 may be stacked together, for example, with a removable adhesive, such that an outer writable/erasable layer 200 may be removed from the magnetic mat 100, presenting a fresh writable/erasable layer 200.

Referring next to FIG. 7, the magnetic mat 100 is shown in another embodiment of the invention. Shown are the writable/erasable layer 200 and a perforated layer 700.

In the embodiment shown in FIG. 7, the perforated layer 700 has been coupled to the surface opposite to the writable/erasable surface 104. The perforated layer 700 may comprise wood, metal or foam, or other material suitable for forming a layer with perforations and being coupled to the magnetic mat 100. The perforated layer 700, in combination with the magnetic mat 100, forms at least one depression or cup suitable for holding items when the magnetic mat 100 is in a substantially horizontal orientation and the perforated layer 700 is facing upwards. The perforated layer 700 may be of any nominal thickness, for example, the perforated layer 700 may be about 1″ thick, resulting in a cup or cups that are about 1″ deep. The perforations may be of any size, shape or number. In the embodiment shown in FIG. 7, perforations are substantially square-shaped and arranged in a 4×4 grid.

The perforated layer 700 allows for additional storage and/or organization of materials in addition to that provided by the magnetically active magnetic layer 102.

While the invention herein disclosed has been described by means of specific embodiments, examples and applications thereof, numerous modifications and variations could be made thereto by those skilled in the art without departing from the scope of the invention set forth in the claims.

What is claimed is:

1. A mat comprising:
a magnetically active layer including a writable/erasable surface configured to accept applied markings which can be erased, the writable/erasable surface further including at least one pre-printed marking.

2. The mat of claim 1, wherein the magnetically active layer comprises steel.

3. The mat of claim 1, wherein the magnetically active layer exhibits magnetism in the range of 1×10⁻⁶ Tesla to 1.25 Tesla.

4. The mat of claim 1, wherein the at least one pre-printed marking is selected from the group consisting of a grid, a ruler and a checkbox.

5. A mat comprising:
a writable/erasable layer including a writable/erasable surface configured to accept applied markings which can be erased, the writable/erasable surface further including at least one pre-printed marking; and
a magnetically active layer coupled to the writable/erasable layer.

6. The mat of claim 5, wherein the magnetically active layer exhibits magnetism in the range of 1×10⁻⁶ Tesla to 1.25 Tesla.

7. The mat of claim 5, wherein the writable/erasable layer is a plastic laminated material.

8. The mat of claim 5, wherein the writable/erasable layer is glass.

9. The mat of claim 5, wherein the at least one pre-printed marking is selected from the group consisting of a grid, a ruler and a checkbox.

10. The mat of claim 5, wherein the magnetically active layer is configured to exhibit features of a Halbach array.

11. The mat of claim 5, further comprising a perforated layer coupled to a surface of the mat opposite to the writable/erasable surface, the perforated layer configured to form depressions when coupled to the surface opposite to the writable/erasable surface.

12. The mat of claim 5, wherein the writable/erasable surface is further configured to be a cutting surface.

13. The mat of claim 5, wherein the mat is configured to allow a bend of at least 90 degrees over a length of the mat.

14. The mat of claim 5, wherein the mat is configured to allow a bend of less than 1 degree over the length of the mat.

15. The mat of claim 5, wherein the mat is configured to allow rolling of the mat into a tube shape.

16. The mat of claim 5, wherein the writable/erasable layer is a first writable/erasable layer, and further comprising a second writable/erasable layer including a second writable/erasable surface, the writable/erasable layer coupled to a face of the magnetically active layer opposite to the first writable/erasable surface.

17. The mat of claim 5, wherein the second writable/erasable layer includes at least one pre-printed marking.

18. The mat of claim 17, wherein the at least one pre-printed marking is selected from the group consisting of a grid, a ruler and a checkbox.

19. The mat of claim 5, further comprising a backing layer coupled to a surface of the magnetically active layer opposite to the writable/erasable surface.

20. The mat of claim 19, wherein the at least one pre-printed marking is selected from the group consisting of a grid, a ruler and a checkbox.

21. The mat of claim 19, wherein the magnetically active layer is configured to exhibit features of a Halbach array.

22. The mat of claim 19, further comprising a perforated layer coupled to the backing layer, the perforated layer configured to form depressions when coupled to the backing layer.

23. The mat of claim 19, wherein the mat is configured to allow a bend of at least 90 degrees over a length of the mat.

24. The mat of claim 23, wherein the backing layer is an adhesive layer.

25. The mat of claim 19, wherein the mat is configured to allow a bend of less than 1 degree over the length of the mat.

26. The mat of claim 25, wherein the backing layer comprises stainless steel.

27. The mat of claim 19, wherein the mat is configured to allow rolling of the mat into a tube shape.

28. The mat of claim 27, wherein the backing layer comprises foam.

29. The mat of claim 19, wherein the magnetically active layer exhibits magnetism in the range of 1×10⁻⁶ Tesla to 1.25 Tesla.

30. The mat of claim 19, wherein the writable/erasable layer is a clear layer, and further comprising an opaque layer interposed between the writable/erasable layer and the magnetically active layer.

31. The mat of claim 30, wherein the at least one pre-printed marking is selected from the group consisting of a grid, a ruler and a checkbox.

32. The mat of claim 30, wherein the magnetically active layer is configured to exhibit features of a Halbach array.

33. The mat of claim 30, further comprising a perforated layer coupled to the backing layer, the perforated layer configured to form depressions when coupled to the backing layer.

34. The mat of claim 30, wherein the mat is configured to allow a bend of at least 90 degrees over a length of the mat.

35. The mat of claim 34, wherein the backing layer is an adhesive layer.

36. The mat of claim 30, wherein the mat is configured to allow a bend of less than 1 degree over the length of the mat.

37. The mat of claim 36, wherein the backing layer comprises stainless steel.

38. The mat of claim 30, wherein the mat is configured to allow rolling of the mat into a tube shape.

39. The mat of claim 38, wherein the backing layer comprises foam.

40. The mat of claim 30, wherein the magnetically active layer exhibits magnetism in the range of 1×10⁻⁶ Tesla to 1.25 Tesla.

41. A mat comprising:
a first clear writable/erasable layer including a first writable/erasable surface on the top of the first clear writable/erasable layer;
a first opaque layer coupled to the bottom of the first clear writable/erasable layer;
a first magnetic layer coupled to the bottom of the first opaque layer;
a second magnetic layer coupled to the bottom of the first magnetic layer;
a second opaque layer coupled to the bottom of the second magnetic layer; and
a second clear writable/erasable layer coupled to the bottom of the second opaque layer, the second writable/erasable layer including a second writable/erasable surface located on the bottom of the second writable/erasable layer.

42. The mat of claim 41, wherein the magnetically active layers exhibit magnetism in the range of 1×10⁻⁶ Tesla to 1.25 Tesla.

43. The mat of claim 41, wherein at least one writable/erasable layer is a plastic laminated material.

44. The mat of claim 41, wherein the first opaque layer includes at least one pre-printed marking.

45. The mat of claim 44, wherein the at least one pre-printed marking is selected from the group consisting of a grid, a ruler and a checkbox.

46. The mat of claim 44, the second opaque layer including at least one pre-printed marking.

47. The mat of claim 46, wherein the at least one pre-printed marking is selected from the group consisting of a grid, a ruler and a checkbox.

48. A mat comprising:
a writable/erasable layer including a writable/erasable surface configured to accept applied markings which can be erased;
a magnetically active layer coupled to the writable/erasable layer; and
a foam backing layer coupled to the magnetically active layer;
wherein the writable/erasable layer, the magnetically active layer and the foam backing layer are configured to allow the mat to be bent to at least a 90 degree angle along a length of the mat.

49. The mat of claim 48, wherein the magnetically active layer exhibits magnetism in the range of 1×10⁻⁶ Tesla to 1.25 Tesla.

50. The mat of claim 48, wherein the magnetically active layer is configured to exhibit features of a Halbach array.
